(19) United States
(12) Patent Application Publication
(10) Pub. No.: US 2009/0172062 A1
(43) Pub. Date: Jul. 2, 2009

(54) EFFICIENT FIXED-POINT IMPLEMENTATION OF AN FFT

(75) Inventors: Wayne Siwei Tang, San Diego, CA (US); Junfeng Wang, San Diego, CA (US); Chen Na, Katy, TX (US)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/334,136

(22) Filed: Dec. 12, 2008

Related U.S. Application Data
(60) Provisional application No. 61/018,200, filed on Dec. 31, 2007.

(51) Int. Cl. G06F 17/14

(52) U.S. Cl. 708/404

(57) ABSTRACT

A fast Fourier transform (FFT) is performed on first-fourth input data points. Real and imaginary portions of the first input data point are stored in first and second registers. Real and imaginary portions of the second input data point are stored in third and fourth registers. Real and imaginary portions of the third input data point are stored in fifth and sixth registers. Real and imaginary portions of the fourth input data point are stored in seventh and eighth registers. Operations are performed in place in the first-eight registers and in a ninth register to generate a first-fourth output data points stored in the registers that represent an FFT of the first-fourth input data points. The radix-4 FFT may be cascaded to perform higher bit-level FFTs on sets of data points. Furthermore, the data points may be reordered between cascaded radix-4 FFTs to enable efficient use of memory.

This application claims the benefit of U.S. Provisional Application No. 61/018,200, filed on Dec. 31, 2007, which is incorporated by reference herein in its entirety.

### BACKGROUND OF THE INVENTION

1. Field of the Invention

The present invention relates to techniques for performing fast Fourier transforms (FFT).

2. Background Art

The discrete Fourier transform (DFT) is a form of Fourier analysis. The DFT transforms a first function to a second function, which may be referred to as the “frequency domain representation” or the “DFT.” The DFT has many applications, including being used to enable spectral analysis and processing in audio and video applications. A fast Fourier transform (FFT) is an algorithm used to determine the DFT and the inverse of the discrete DFT. The FFT enables the DFT to be determined more quickly than other techniques. Many electronic devices that are used in audio and/or video applications include a processor and/or logic configured to perform the FFT algorithm.

For instance, ARM (Advanced RISC Machine) central processing units (CPUs) frequently used in electronic devices may be configured to perform the FFT algorithm. The ARM architecture is a 32-bit RISC processor architecture widely used in embedded designs. Because of their low power consumption, ARM CPUs are frequently used in mobile electronic devices, which are frequently battery powered.

A need exists for improved ways of performing the FFT algorithm in processors, such as in ARM CPUs. Conventionally, FFTs performed in processors that have limited resources are implemented according to a radix-2 technique, which has disadvantages. For example, performing an FFT in an ARM processor according to a radix-2 technique is relatively slow. A relatively large amount of time is required for computations, and a large amount of power is consumed as a result. Furthermore, the radix-2 technique does not take advantage of the ARM CPU architecture. Still further, performing an FFT in an ARM processor according to a radix-2 technique results typically results with output signals having relatively poor dynamic range.

Thus, what is desired are improved techniques for performing the FFT algorithm in processors, including in processors having limited resources and/or used in mobile devices.

### BRIEF SUMMARY OF THE INVENTION

Embodiments of the present invention provide a way of implementing fast Fourier transforms (FFTs) more efficiently. An FFT is enabled to be performed “in place” in a small set of registers. Performing an FFT in this manner may reduce or eliminate a number of memory accesses that are required by conventional techniques. Furthermore, the FFT may be cascaded to perform higher bit-level FFTs on larger sets of data points. The data points may be reordered between cascaded FFTs to enable further efficient use of memory.

In one implementation, a method for performing a FFT on a plurality of input data points is provided. The plurality of input data points includes a first input data point, a second input data point, a third input data point, and a fourth input data point. A real portion of the first input data point is stored in a first register and an imaginary portion of the first input data point is stored in a second register. A real portion of the second input data point is stored in a third register and an imaginary portion of the second input data point is stored in a fourth register. A real portion of the third input data point is stored in a fifth register and an imaginary portion of the third input data point is stored in a sixth register. A real portion of the fourth input data point is stored in a seventh register and an imaginary portion of the fourth input data point is stored in an eighth register. Operations are performed on the first-fourth input data points in place in the first-eight registers and in a ninth register to generate a first output data point, a second output data point, a third output data point, and a fourth output data point.

In another implementation, a system for performing an FFT is provided. The system includes an FFT module and a plurality of registers that includes a first register, a second register, a third register, a fourth register, a fifth register, a sixth register, a seventh register, an eighth register, and a ninth register. The FFT module is configured to store a real portion of the first input data point in the first register and an imaginary portion of the first input data point in the second register, a real portion of the second input data point in the third register and an imaginary portion of the second input data point in the fourth register, a real portion of the third input data point in the fifth register and an imaginary portion of the third input data point in the sixth register, and a real portion of the fourth input data point in the seventh register and an imaginary portion of the fourth input data point in the eighth register. The FFT module is configured to perform operations on the first-fourth input data points in place in the first-eight registers and in the ninth register to generate a first output data point, a second output data point, a third output data point, and a fourth output data point.

In still another implementation, a method for performing a radix-M FFT is provided. A first plurality of data points is received in a first order. The first plurality of data points is reordered into a second order. A radix-N FFT operation is performed on the first plurality of data points in groups of N data points received according to the second order to generate a second plurality of data points. A radix-N FFT operation is performed on the second plurality of data points in groups of N data points sequentially received to generate a third plurality of data points. The third plurality of data points is reordered into a third order. A radix-N FFT operation is performed on the third plurality of data points in groups of N data points received according to the third order to generate a fourth plurality of data points.

In still another implementation, a system for performing a radix-M FFT is provided. The system includes a first permutation module, a first FFT module, a second FFT module, a second permutation module, and a third FFT module. The first permutation module is configured to receive a first plurality of data points in a first order, and to reorder the first plurality of data points into a second order. The first FFT module is configured to receive the first plurality of data points in the second order, and to perform a radix-N FFT operation on the first plurality of data points in groups of N data points received according to the second order to generate a second plurality of data points. The second FFT module is configured to receive the second plurality of data points, and to perform a radix-N FFT operation on the second plurality of data points in groups of N data points sequentially received to generate a third plurality of data points. The second permutation module is configured to receive the third plurality of data points, and to reorder the third plurality of data points into a third order. The third FFT module is configured to receive the third plurality of data points in the third order, and to perform a radix-N FFT operation on the third plurality of data points in groups of N data points received according to the third order to generate a fourth plurality of data points.

Still further, the system may include a scaling module configured to scale at least one of the second plurality of data points, third plurality of data points, and fourth plurality of data points according a corresponding set of twiddle factors.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an audio processing system.

FIG. 2 shows a block diagram of an audio processor.

FIG. 3 shows a radix-4 FFT butterfly, according to an example embodiment of the present invention.

FIG. 4 shows an input data sample.

FIG. 5 shows a 16-sample FFT configuration, according to an embodiment of the present invention.

FIG. 6 shows a block diagram of an FFT module that includes an index table, according to an example embodiment of the present invention.

FIG. 7 shows a 16-sample FFT configuration, according to an embodiment of the present invention.

FIG. 8 shows a flowchart for performing a radix-M FFT, according to an example embodiment of the present invention.

FIG. 9 shows a block diagram of a radix-M FFT system, according to an example embodiment of the present invention.

FIG. 10 shows a table that includes an example mapping for reordering 64 data points, according to an embodiment of the present invention.

FIG. 11 shows a table that includes an example mapping for reordering 64 data points, according to an embodiment of the present invention.

FIG. 12 shows a flowchart for performing a radix-N FFT, according to an example embodiment of the present invention.

FIG. 13 shows a radix-4 FFT module configured to interact with a set of registers to perform a radix-4 FFT operation, according to an example embodiment of the present invention.

FIGS. 14A and 14B show a flowchart for performing a radix-4 FFT in place in a set of registers, according to an example embodiment of the present invention.

FIG. 15 shows a block diagram of a radix-M FFT system, according to an example embodiment of the present invention.

FIG. 16 shows a table that lists an example set of twiddle factors for 64 data points, according to an embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### Example Embodiments

The example embodiments described herein are provided for illustrative purposes, and are not limiting. The examples described herein may be adapted to in various ways for implementation in many types of processors and/or processing logic, including ARM CPUs. Furthermore, additional structural and operational embodiments, including modifications/alterations, will become apparent to persons skilled in the relevant art(s) from the teachings herein.

Embodiments enable faster computations in ARM CPUs and use less power than conventional techniques. Further embodiments handle twiddle-factors, fixed-point shifting, and overflow protection in unique ways. Embodiments improve the dynamic range significantly compared to conventional implementation. In some applications, embodiments can replace a hardware accelerator used for FFT computations. Embodiments are applicable to a variety of applications, including audio applications.

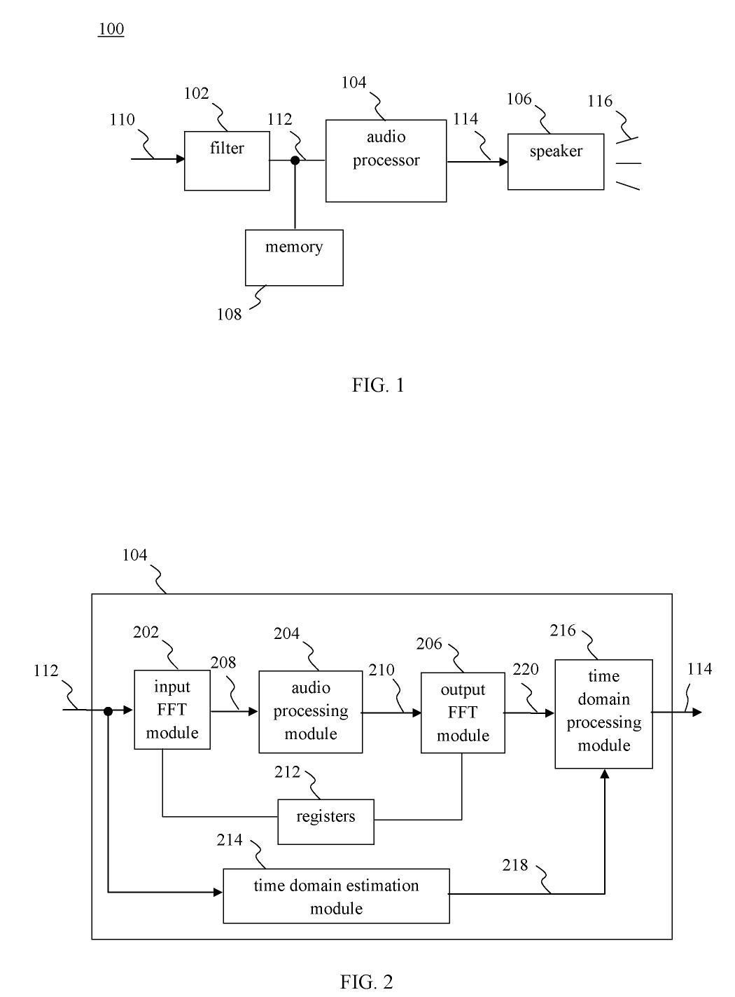

For example, FIG. 1 shows a block diagram of an audio processing system 100. System 100 may be implemented in a processor and/or in processing logic, such as an ARM CPU. As shown in FIG. 1, system 100 includes a filter 102, an audio processor 104, a speaker 106, and a memory 108. In system 100, filter 102 receives an input audio data signal 110. Input audio data signal 110 may include a stream of audio data in any suitable form. Filter 102 filters the audio data received on input audio data signal 110, and generates a filtered audio data signal 112. Memory 108 receives the filtered audio data on filtered audio data signal 112, and optionally stores the filtered audio data. Audio processor 104 may receive the filtered audio data on filtered audio data signal 112 from filter 102 and/or from memory 108. Audio processor 104 performs audio processing of the received audio data. Audio processor 104 generates a processed audio data signal 114. Speaker 106 receives processed audio data signal 114, and generates an audio signal 116 based on the processed audio data received on processed audio data signal 114.

Note that filter 102 and audio processor 104 may be implemented in hardware, software, firmware, or any combination thereof. For example, filter 102 and/or audio processor 104 may be implemented as one or more processors and/or as computer code configured to be executed in one or more processors, such as an ARM CPU. Alternatively, filter 102 and/or audio processor 104 may be implemented as hardware logic/electrical circuitry. Memory 108 may be a memory device such as a RAM device, a ROM device, etc., and/or any other suitable type of storage medium, such as a hard disc drive. Speaker 106 may be any type of speaker configured for broadcasting audio.

System 100 may be implemented in any type of electronic device that may be configured with audio processing functionality, including a desktop computer (e.g., a personal computer, etc.), a mobile computing device (e.g., a cell phone, smart phone, a personal digital assistant (PDA), a laptop computer, a notebook computer, etc.), a mobile email device (e.g., a RIM Blackberry® device), an audio device (e.g., an MP3 or other music file format player such as an Apple iPod) or other electronic device. Although described above as a system for processing audio, system 100 may be used to process other forms of data, including video data and/or other data.

Many processors, including ARM processors, are typically configured to perform a fast Fourier transform (FFT) operation in a radix-2 fashion, where two input data samples or points (e.g., received on filtered audio data signal 112) are processed in a radix-2 FFT butterfly configuration. The radix-2 FFT butterflies may be used in groups to process input audio data in larger groups of samples than two data samples. For example, two stages of radix-2 FFT butterflies may be cascaded to process four input data samples, four stages of radix-2 FFT butterflies may be cascaded to process sixteen input data samples, six stages of radix-2 FFT butterflies may be cascaded to process sixty-four input data samples, etc.

FIG. 2 shows a block diagram of audio processor 104, according to an example embodiment. As shown in FIG. 2, audio processor 104 includes an input FFT module 202, an audio processing module 204, an output FFT module 206, registers 212, a time domain estimation module 214, and a time domain processing module 216. Input FFT module 202 receives and performs an FFT operation on the audio data of filtered audio data signal 112. As a result, input FFT module 202 converts the audio data from the time domain to the frequency domain, and generates frequency domain audio data 208. Audio processing module 204 receives frequency domain audio data 208, and performs audio processing on the audio data of frequency domain audio data 208. For example, audio processing module 204 may perform filtering, an equalization process, etc., on the audio data in the frequency domain. Audio processing module 204 generates a frequency domain processed audio data signal 210. Output FFT module 206 receives and performs an FFT operation on frequency domain processed audio data signal 210. Output FFT module 206 converts the audio data from frequency domain to the time domain, and generates a frequency domain processed time domain audio data signal 220.

As shown in FIG. 2, time domain estimation module 214 receives filtered audio data signal 112. Time domain estimation module 214 is configured to perform time domain estimation on filtered audio data signal 112, as would be known to persons skilled in the relevant art(s). Time domain estimation module 214 generates a time domain estimation signal 218. Frequency domain processed time domain audio data signal 220 and time domain estimation signal 218 are received by time domain processing module 216. Time domain processing module 216 is configured to perform time domain processing of frequency domain processed time domain audio data signal 220, as would be known to persons skilled in the relevant art(s), and generates processed audio data signal 114.

Input FFT module 202, audio processing module 204, output FFT module 206, time domain estimation module 214, and time domain processing module 216 may be implemented in hardware, software, firmware, or any combination thereof. For example, input FFT module 202, audio processing module 204, output FFT module 206, time domain estimation module 214, and/or time domain processing module 216 may be implemented as computer code configured to be executed in one or more processors, such as an ARM CPU. Alternatively, input FFT module 202, audio processing module 204, output FFT module 206, time domain estimation module 214, and/or time domain processing module 216 may be implemented as hardware logic/electrical circuitry.

Registers 212 store audio data during processing performed by input FFT module 202 and output FFT module 206. Registers 212 may be accessed by FFT modules 202 and 206 faster than can memory 108, and thus are preferable to be used by FFT modules 202 and 206 to save computational time. Many processors, such as ARM processors, have limited resources. In an ARM processor implementation, registers 212 includes 16 registers. One of the registers is used for a program counter, and another of the registers is used for a stat pointer. Thus, at most 14 of the 16 registers of registers 212 are available for FFT processing by input and output FFT modules 202 and 206. Typically, further registers of the 14 registers may be required for further housekeeping procedures, and thus in some cases, only 9 or 10 of the 16 registers of registers 212 are available for usage during FFT processing. Because of the limited number of registers of registers 212 that are available for FFT processing, typically input and output FFT modules 202 and 206 are configured to perform radix-2 FFT operations to conserve registers.

Embodiments of the present invention enable use of a radix-4 FFT in an ARM processor. For example, FIG. 3 shows a radix-4 FFT butterfly 300, according to an embodiment of the present invention. Radix-4 FFT butterfly 300 may be implemented in an ARM processor to perform a radix-4 FFT operation, and may be implemented in each of input and output FFT modules 202 and 206. In embodiments, groups of radix-4 FFT butterflies 300 may be used to perform FFT operations of any size (e.g., 2ⁿ), including operations on input sample sizes of 4, 8, 16, 32, 64, etc.

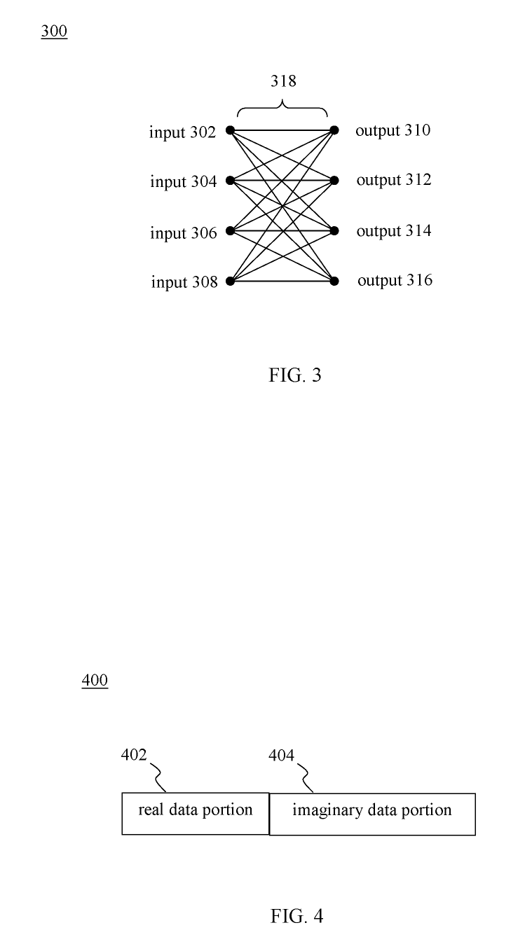

As shown in FIG. 3, radix-4 FFT butterfly 300 has a butterfly portion 318 that receives inputs 302, 304, 306, and 308, and performs a FFT butterfly operation. Butterfly portion 318 generates outputs 310, 312, 314, and 316. Radix-4 FFT butterfly 300 may be implemented by a subset of the 16 registers of registers 212. FIG. 4 shows an input data sample or point 400 that may be received by one of inputs 302-308. As shown in FIG. 4, input data point 400 has a real data portion 402 and an imaginary data portion 404. Real data portion 402 may be held in a first register of registers 212, and imaginary data portion 404 may be held in a second register of registers 212. Thus, four input data points 400 received by radix-4 FFT butterfly 300 at inputs 302-308 may be held in eight registers of registers 212. Operations performed by radix-4 FFT butterfly 300 on the sample data held in the eight registers are performed such that rather than using additional registers of registers 212, the sample data held in the eight registers is overwritten when no longer needed. In other words, operations performed by radix-4 FFT butterfly 300 on the data stored in the 8 registers are performed in place in the 8 registers. Thus, the limited number of registers of registers 212 is preserved.

In embodiments, one of the registers of registers 212 is used as an input and output buffer index. Embodiments may provide a significant savings in processor resources (e.g., 40% savings). In an embodiment, 17 processor instructions may be used to execute a radix-4 FFT butterfly operation of radix-4 FFT butterfly 300. In alternative embodiments, other numbers of instructions may be used.

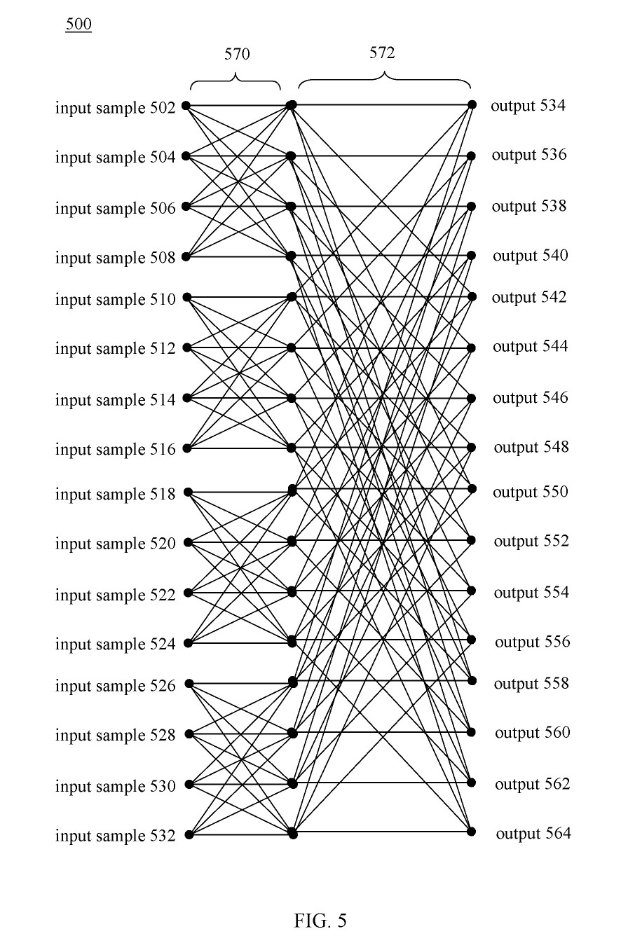

As described above, groups of radix-4 FFT butterflies 300 may be used to perform FFT operations of any size. For example, FIG. 5 shows a 16-sample FFT 500, according to an embodiment of the present invention. As shown in FIG. 5, 16-sample FFT 500 is formed of first and second stages 570 and 572, which each include radix-4 FFT butterflies 300.

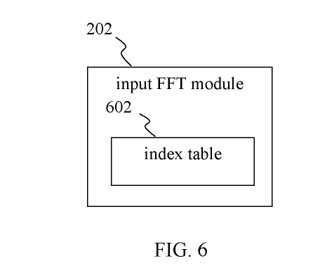

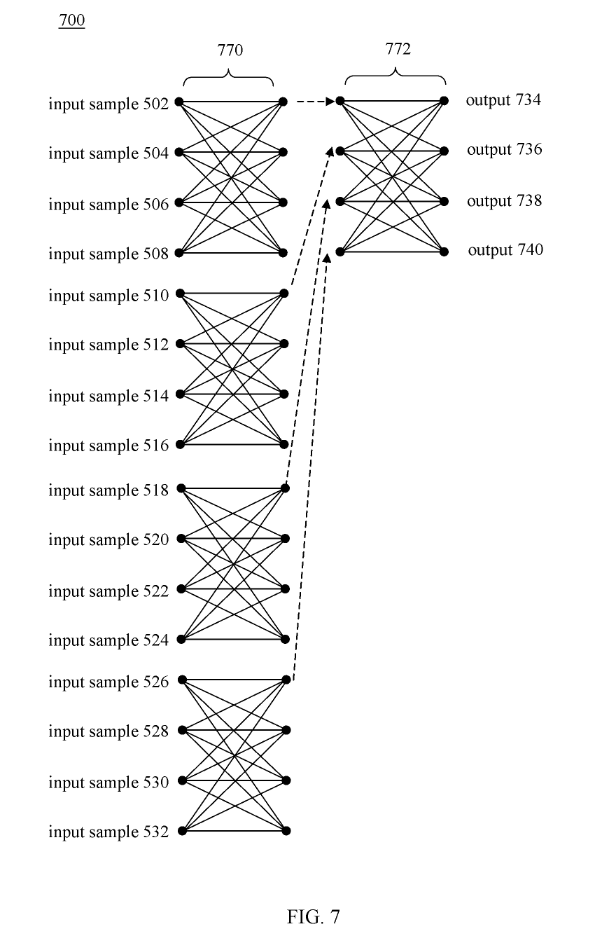

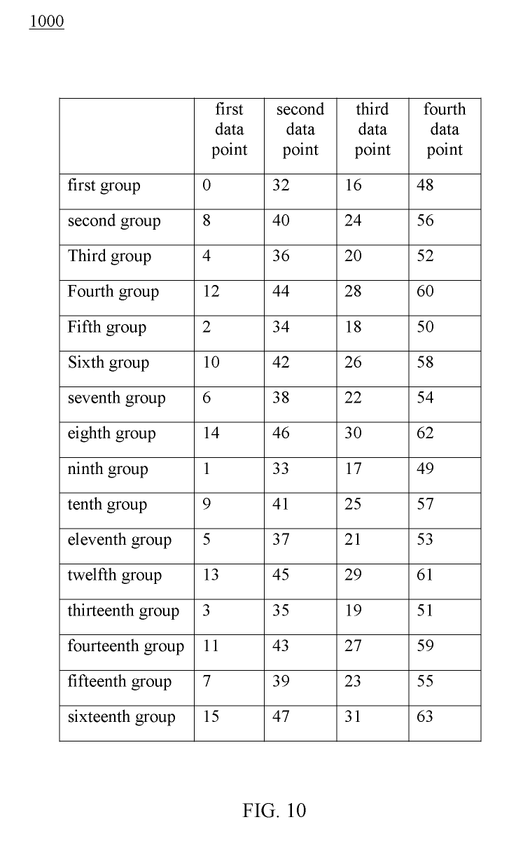

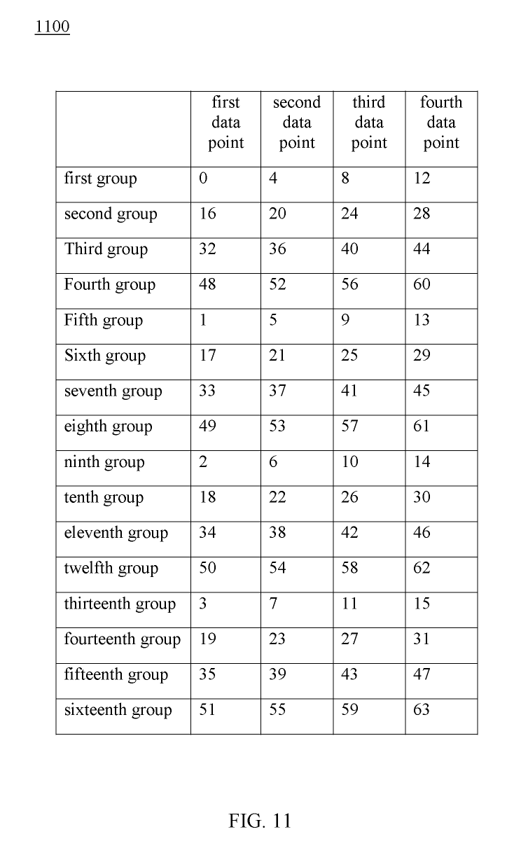

In an embodiment, input and/or output FFT 202 and 206 may include an index table 602, as shown in FIG. 6. Index table 602 maps physical locations of outputs of a previous stage (e.g., stage 570) to physical locations of inputs of a next stage (e.g., stage 572) so that FFT operations by radix-4 FFT butterflies 300 can be performed more efficiently. FIG. 7 shows a 16-sample FFT 700, according to an embodiment of the present invention. As shown in FIG. 7, 16-sample FFT 700 is formed of first and second stages 770 and 772, which each include radix-4 FFT butterflies 300 (only a first radix-4 FFT butterfly 300 is shown in second stage 772, for ease of illustration). Index table 602 may enable the mapping illustrated in FIG. 7 indicated by the four dotted arrows. As a result, outputs of radix-4 FFT butterflies 300 of first stage 770 are arranged in memory (e.g., registers 212) by index table 602 to enable FFT operation by radix-4 FFT butterflies 300 of a next stage in a similar manner as performed by radix-4 FFT butterflies of the previous stage (e.g., the input data samples are similarly located in registers 212). Examples of index table 602 are described below (e.g., with respect to FIGS. 10 and 11).

Embodiments enable improved dynamic range. For example, as described above, conventional implementations of FFTs in ARM processors use radix-2 butterfly configurations. For a 16-data sample input signal, a radix-2 butterfly configuration requires four stages of radix-2 butterflies. In contrast, a 16-data sample input signal processed by radix-4 FFT butterflies 300 uses two stages of radix-4 butterflies (e.g., as shown in FIGS. 5 and 7). In the conventional case, bits may be lost due to the relatively high number of stages (4 stages of radix-2 butterflies) requiring a higher number of calculations. In contrast, an embodiment having two stages of radix-4 butterflies does not suffer from the bit loss of the conventional case.

Example embodiments for input and output FFT modules 202 and 206 are described in the next subsection, and example embodiments for optionally handling twiddle factors are described in the subsequent subsection.

### Example Embodiments for FFT Modules and for Performing FFT Operations

Example embodiments are described in this subsection for FFT modules 202 and 206, and for performing FFT operations therewith. These example embodiments are provided for illustrative purposes, and are not limiting. Although described below with reference to audio signal processing, the examples described herein may be adapted to other types of signal processing. Furthermore, additional structural and operational embodiments, including modifications/alterations, will become apparent to persons skilled in the relevant art(s) from the teachings herein.

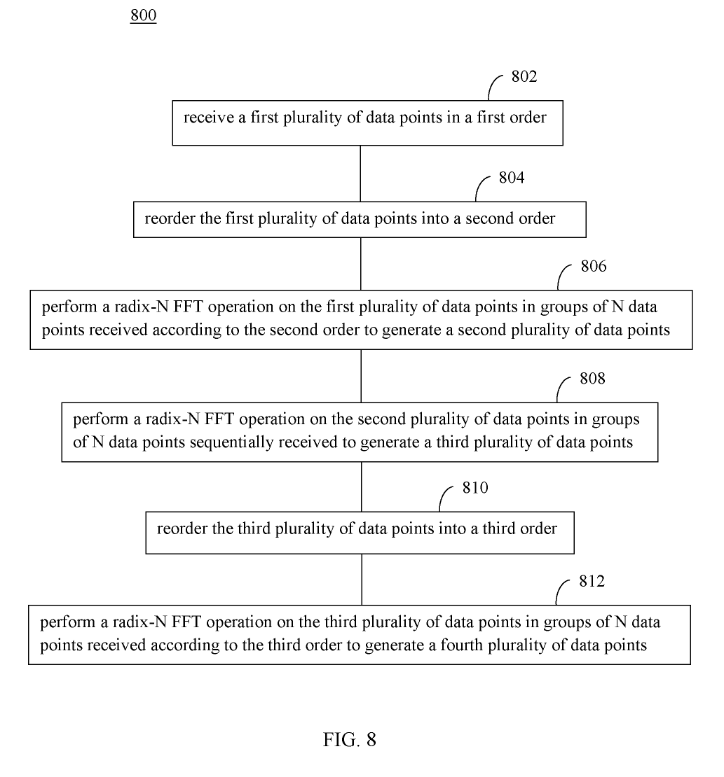

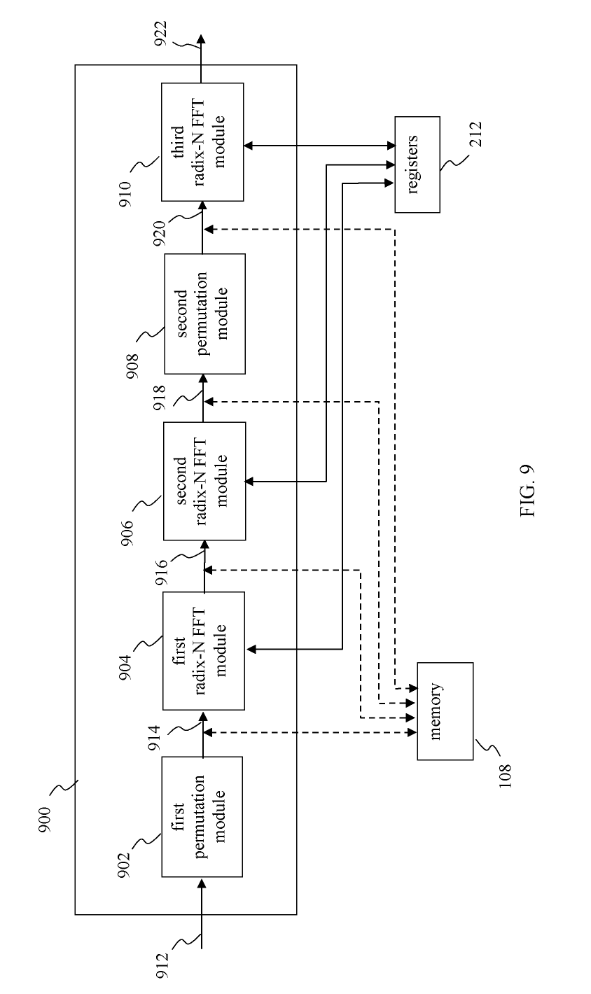

Embodiments of FFT modules 202 and 206 may operate in various ways. For example, FIG. 8 shows a flowchart 800 for performing a radix-M FFT, according to an example embodiment of the present invention. Flowchart 800 may be performed by one or both of FFT modules 202 and 206, for instance. Flowchart 800 is described with respect to FIG. 9, which shows a radix-M FFT system 900, according to an example embodiment of the present invention. One or both of FFT modules 202 and 206 may be configured according to radix-M FFT system 900, in an example embodiment. As shown in FIG. 9, system 900 includes a first permutation module 902, a first radix-N FFT module 904, a second radix-N FFT module 906, a second permutation module 908, and a third radix-N FFT module 910. In an embodiment, system 900 may be implemented in a processor or in processing logic, such as an ARM CPU. Note that the values for M and N may be any suitable values, such as M being equal to 16, 32, 64, etc., and N being equal to 4, for example.

Flowchart 800 and system 900 are described as follows. Other structural and operational embodiments will be apparent to persons skilled in the relevant art(s) based on the discussion regarding flowchart 800 and system 900. For example, fewer than or greater numbers of radix-N FFT modules than the three as shown in FIG. 9 may be present, depending on the value of M. Accordingly, fewer than or greater numbers of radix-N FFT operations than the three shown in FIG. 8 (steps 806, 808, and 812) may be present in flowchart 800, depending on the value of M.

Referring to flowchart 800 in FIG. 8, in step 802, a first plurality of data points is received in a first order. For example, in an embodiment, first permutation module 902 shown in FIG. 9 may receive a first plurality of data points 912. In an embodiment, first plurality of data points 912 may be received from memory 108. First plurality of data points 912 may be a plurality of data points received in filtered audio data signal 112 or frequency domain processed audio data signal 210 shown in FIG. 2. First plurality of data points 912 may include a number of data points that can be processed together by system 900, depending on the particular implementation. For example, if system 900 is configured to perform a radix-64 FFT operation, first plurality of data points 912 may include 64 data points. If system 900 is configured to perform a radix-16 FFT operation, first plurality of data points 912 may include 16 data points. Data points of first plurality of data points 912 may be received in a particular order, referred to as a first order. Each data point received in first plurality of data points 912 may have a real portion and an imaginary portion similar to data point 400 shown in FIG. 4, and may have any suitable bit length, including having a 16 bit length real portion and a 16 bit length imaginary portion.

In step 804, the first plurality of data points is reordered into a second order. For example, in an embodiment, first permutation module 902 shown in FIG. 9 may perform step 804. First permutation module 902 may be configured to reorder the data points of first plurality of data points 912 from the first order into a second order. For instance, first permutation module 902 may reorder first plurality of data points 912 from the first order into a random or pseudorandom order. By reordering first plurality of data points 912, a number of memory input/output (I/O) operations that must be performed by system 900 (e.g., by first radix-N FFT module 904) is reduced. The reordering enables subsequent memory I/O operations to be sequential. As shown in FIG. 9, first permutation module 902 generates a reordered first plurality of data points 914.

Reordered first plurality of data points 914 may be stored in memory 108, in an embodiment.

For example, first plurality of data points 912 may include 64 data points that are ordered data point 0 through data point 63. In an embodiment, first permutation module 902 may be configured to reorder the 64 data points of first plurality of data points 912 as indicated in a table. For example, FIG. 10 shows a table 1000 that includes a mapping for reordering 64 data points, according to an embodiment of the present invention. In table 1000, each row lists a group of four data points, for ease of illustration. The order of data points in table 1000 is sequential from left to right in each row, and is sequential on a row-by-row basis, from the first group listed in the first row to the sixteenth group listed in the sixteenth row.

As indicated in table 1000, data point 0 through data point 63 are reordered into the following sequential order of data point 0, data point 32, data point 16, data point 48, data point 8, data point 40, data point 24, data point 56, data point 4, data point 36, data point 20, data point 52, data point 12, data point 44, data point 28, data point 60, data point 2, data point 34, data point 18, data point 50, data point 10, data point 42, data point 26, data point 58, data point 6, data point 38, data point 22, data point 54, data point 14, data point 46, data point 30, data point 62, data point 1, data point 33, data point 17, data point 49, data point 9, data point 41, data point 25, data point 57, data point 5, data point 37, data point 21, data point 53, data point 13, data point 45, data point 29, data point 61, data point 3, data point 35, data point 19, data point 51, data point 11, data point 43, data point 27, data point 59, data point 7, data point 39, data point 23, data point 55, data point 15, data point 47, data point 31, and data point 63.

In step 806, a radix-N FFT operation is performed on the first plurality of data points in groups of N data points received according to the second order to generate a second plurality of data points. For example, in an embodiment, first radix-N FFT module 904 shown in FIG. 9 may perform step 806. As shown in FIG. 9, first radix-N FFT module 904 receives reordered first plurality of data points 914 (ordered in the second order). Reordered first plurality of data points 914 may be received from memory 108 or from first permutation module 902. First radix-N FFT module 904 is configured to perform a radix-N FFT operation on reordered first plurality of data points 914 to generate a second plurality of data points 916.

For example, N may be equal to 4, and thus radix-N FFT module 904 may be configured to perform a radix-4 FFT operation on reordered first plurality of data points 914. In such an embodiment, radix-N FFT module 904 may be configured to perform the FFT operation on groups of 4 data points received in reordered first plurality of data points 914, such as each of the 16 groups of data points shown in table 1000 in FIG. 10, received in the indicated order. As shown in FIG. 9, first radix-N FFT module 904 may store a group of 4 data points in registers 212, and may operate on the 4 data points in place in registers 212, despite a limited number of available registers in registers 212, as described above. By operating on the 4 data points in place in registers 212, undesired memory I/O operations may be eliminated to save time and processing resources.

First radix-N FFT module 904 may be configured to perform the radix-N FFT operation in various ways. Example embodiments for radix-N FFT operations that may be performed by radix-N FFT module 904 are described further below. Second plurality of data points 916 generated by first radix-N FFT module 904 may be stored in memory 108 (as indicated by a dotted line in FIG. 9), in an embodiment.

In step 808, a radix-N FFT operation is performed on the second plurality of data points in groups of N data points sequentially received to generate a third plurality of data points. For example, in an embodiment, second radix-N FFT module 906 shown in FIG. 9 may perform step 808. As shown in FIG. 9, second radix-N FFT module 906 receives second plurality of data points 916 in a sequential manner from first radix-N FFT module 904. Second plurality of data points 916 may be received from memory 108 or from first radix-N FFT module 904. Second radix-N FFT module 906 is configured to perform a radix-N FFT operation on second plurality of data points 916 to generate a third plurality of data points 918.

For example, N may be equal to 4, and thus the second radix-N FFT module 906 may be configured to perform a radix-4 FFT operation on second plurality of data points 916. In such an embodiment, second radix-N FFT module 906 may be configured to perform the FFT operation on groups of 4 data points received in second plurality of data points 916. As shown in FIG. 9, second radix-N FFT module 906 may store and operate on the four data points in place in registers 212, despite a limited number of available registers in registers 212, as described above.

Second radix-N FFT module 906 may be configured to perform the radix-N FFT operation in various ways. Example embodiments for radix-N FFT operations that may be performed by second radix-N FFT module 906 are described further below. Third plurality of data points 918 generated by second radix-N FFT module 906 may be stored in memory 108 (as indicated by a dotted line in FIG. 9), in an embodiment.

In step 810, the third plurality of data points is reordered into a third order. For example, in an embodiment, second permutation module 908 shown in FIG. 9 may perform step 810. Second permutation module 908 may be configured to reorder the data points of third plurality of data points 918 from the sequential order output by second radix-N FFT module 906 into a third order. For instance, second permutation module 908 may reorder third plurality of data points 918 in a random or pseudorandom order. By reordering third plurality of data points 918, a number of memory input/output (I/O) operations that must be performed by system 900 (e.g., by third radix-N FFT module 910) is reduced. The reordering enables subsequent memory I/O operations, including the final FFT results output from system 900, to be sequential. As shown in FIG. 9, second permutation module 908 generates a reordered third plurality of data points 920.

Reordered third plurality of data points 920 may be stored in memory 108, in an embodiment.

For example, third plurality of data points 918 may include 64 data points that are ordered data point 0 through data point 63. In an embodiment, third permutation module 908 may be configured to reorder the 64 data points of third plurality of data points 918 as indicated in a table similar to table 1000. For example, FIG. 11 shows a table 1100 that includes a mapping for reordering 64 data points, according to an embodiment of the present invention. In table 1100, each row lists a group of four data points, for ease of illustration. The order of data points in table 1100 is sequential from left to right in each row, and is sequential on a row-by-row basis, from the first group listed in the first row to the sixteenth group listed in the sixteenth row.

As indicated in table 1100, data point 0 through data point 63 are reordered into the following sequential order of data point 0, data point 4, data point 8, data point 12, data point 16, data point 20, data point 24, data point 28, data point 32, data point 36, data point 40, data point 44, data point 48, data point 52, data point 56, data point 60, data point 1, data point 5, data point 9, data point 13, data point 17, data point 21, data point 25, data point 29, data point 33, data point 37, data point 41, data point 45, data point 49, data point 53, data point 57, data point 61, data point 2, data point 6, data point 10, data point 14, data point 18, data point 22, data point 26, data point 30, data point 34, data point 38, data point 42, data point 46, data point 50, data point 54, data point 58, data point 62, data point 3, data point 7, data point 11, data point 15, data point 19, data point 23, data point 27, data point 31, data point 35, data point 39, data point 43, data point 47, data point 51, data point 55, data point 59, and data point 63.

In step 812, a radix-N FFT operation is performed on the third plurality of data points in groups of N data points received according to the third order to generate a fourth plurality of data points. For example, in an embodiment, third radix-N FFT module 910 shown in FIG. 9 may perform step 812. As shown in FIG. 9, third radix-N FFT module 910 receives reordered third plurality of data points 920 (ordered in the third order). Reordered third plurality of data points 920 may be received from memory 108 or from second permutation module 908. Third radix-N FFT module 910 is configured to perform a radix-N FFT operation on reordered third plurality of data points 920 to generate a fourth plurality of data points 922. Fourth plurality of data points 922 is output from system 900, and may be received by a subsequent module (e.g., audio processing module 204 or time domain processing module 216 shown in FIG. 2)

For example, N may be equal to 4, and thus third radix-N FFT module 910 may be configured to perform a radix-4 FFT operation on reordered third plurality of data points 920. In such an embodiment, third radix-N FFT module 910 may be configured to perform the FFT operation on groups of four data points received in reordered third plurality of data points 920, such as each of the 16 groups of data points shown in table 1100 in FIG. 11, received in the indicated order. As shown in FIG. 9, third radix-N FFT module 910 may store the four data points in registers 212, and may operate on the four data points in place in registers 212, despite a limited number of available registers in registers 212, as described above. By operating on the four data points in place in registers 212, undesired memory I/O operations may be eliminated to save time and processing resources.

Third radix-N FFT module 910 may be configured to perform the radix-N FFT operation in various ways. Example embodiments for radix-N FFT operations that may be performed by third radix-N FFT module 910 are described further below.

Fourth plurality of data points 922 may be stored in memory 108 by third radix-N FFT module 910, in an embodiment. Fourth plurality of data points 922 may be a plurality of data points in frequency domain audio data 208 (output by input FFT module 202) or frequency domain processed time domain audio data signal 220 (output by output FFT module 206) in FIG. 2.

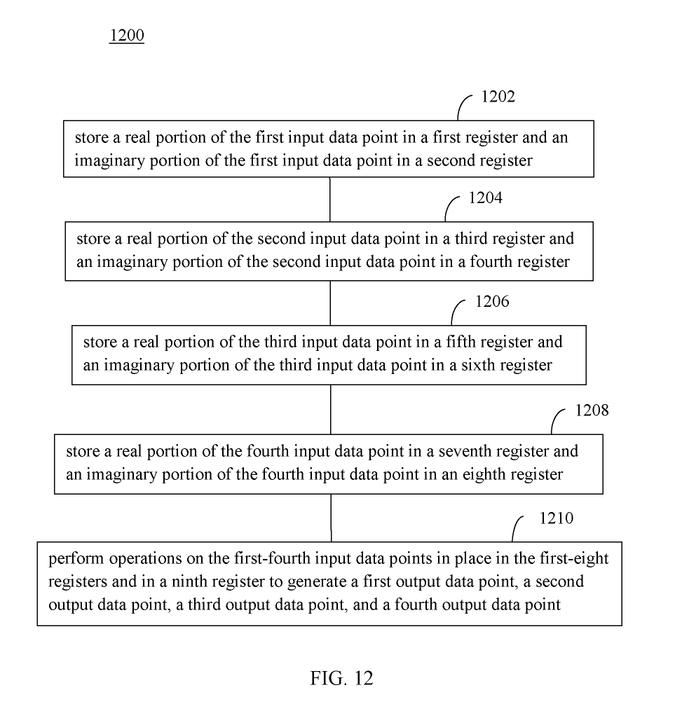

As described above, first-third radix-N FFT modules 904, 906, and 910 may be configured to perform a radix-N FFT operation in various ways. For example, FIG. 12 shows a flowchart 1200 for performing a radix-N FFT, according to an example embodiment of the present invention. Flowchart 1200 may be performed by one or more of first-third radix-N FFT modules 904, 906, and 910 and/or during steps 806, 808, and/or 812 of flowchart 800, for instance. Other structural and operational embodiments will be apparent to persons skilled in the relevant art(s) based on the discussion regarding flowchart 1200.

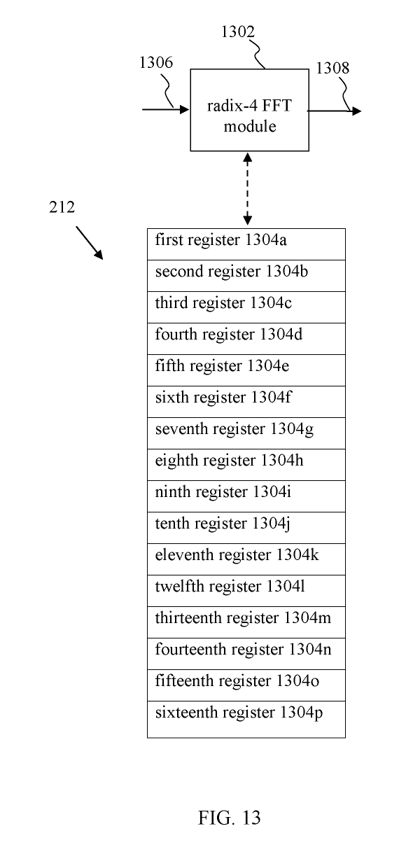

For illustrative purposes, flowchart 1200 is described below in the context of a radix-4 FFT embodiment. For instance, FIG. 13 shows a radix-4 FFT module 1302 configured to interact with sixteen registers 1304a-1304p of registers 212 to perform a radix-4 FFT operation, according to an example embodiment of the present invention. Any one or more of first-third radix-N FFT modules 904, 906, and 910 shown in FIG. 9 may be configured similarly to radix-4 FFT module 1302, in embodiments. In an embodiment, radix-4 FFT module 1302 and registers 212 may be implemented in a processor or in processing logic, such as an ARM CPU that includes sixteen registers.

In the following example, radix-4 FFT module 1302 is described as performing an FFT on a group of four input data points: a first input data point, a second input data point, a third input data point, and a fourth input data point. In embodiments, the four data points may be a group of four data points of reordered first plurality of data points 914 received by first radix-N FFT module 904 (e.g., one of the first-sixteenth groups of data points in table 1100 of FIG. 11), a group of four data points of second plurality of data points 916 received by second radix-N FFT module 906, or a group of four data points of reordered third plurality of data points 920 received by third radix-N FFT module 910 (e.g., one of the first-sixteenth groups of data points in table 1200 of FIG. 12). The first-fourth input data points correspond to first-fourth inputs 302-308 (shown in FIG. 3) input to radix-4 FFT butterfly 300. Flowchart 1200 is described as follows.

In step 1202, a real portion of the first input data point is stored in a first register and an imaginary portion of the first input data point is stored in a second register. For instance, referring to FIG. 13, radix-4 FFT module 1302 may be configured to receive a first-fourth input data point signal 1306 from memory 108 (FIG. 9) or from a preceding permutation module or FFT module, which includes a group of four data points. Radix-4 FFT module 1302 may be configured to store a real portion of the first input data point in first register 1304a and an imaginary portion of the first input data point in second register 1304b.

In step 1204, a real portion of the second input data point is stored in a third register and an imaginary portion of the second input data point is stored in a fourth register. For instance, radix-4 FFT module 1302 may be configured to store a real portion of the second input data point in third register 1304c and an imaginary portion of the second input data point in fourth register 1304d.

In step 1206, a real portion of the third input data point is stored in a fifth register and an imaginary portion of the third input data point is stored in a sixth register. For instance, radix-4 FFT module 1302 may be configured to store a real portion of the third input data point in fifth register 1304e and an imaginary portion of the third input data point in sixth register 1340f.

In step 1208, a real portion of the fourth input data point is stored in a seventh register and an imaginary portion of the fourth input data point is stored in an eighth register. For instance, radix-4 FFT module 1302 may be configured to store a real portion of the fourth input data point in seventh register 1304g and an imaginary portion of the fourth input data point in eighth register 1304h.

In step 1210, operations are performed on the first-fourth input data points in place in the first-eight registers and in a ninth register to generate a first output data point, a second output data point, a third output data point, and a fourth output data point. For instance, in an embodiment, radix-4 FFT module 1302 may be configured to perform operations on the first-fourth input data points in place in first-eight registers 1304a-1304h and in ninth register 1304i (e.g., which may function as a “dummy” or temporary data register) to generate a first output data point, a second output data point, a third output data point, and a fourth output data point. Radix-4 FFT module 1302 may output the first-fourth output data points on a first-fourth output data point signal 1308, which may be stored in memory 108 (FIG. 9) and/or may be provided to a subsequent permutation module or FFT module. The first-fourth output data points resulting from the radix-4 FFT algorithm performed by radix-4 FFT module 1302 correspond to first-fourth outputs 310-316 output by radix-4 FFT butterfly 300 shown in FIG. 3.

In embodiments, a radix-4 FFT algorithm may be performed in step 1210 by radix-4 FFT module 1302 that uses first-ninth registers 1304a-1304i. By performing the radix-4 FFT algorithm in place in first-ninth registers 1304a-1304i, rather than having to perform the radix-4 FFT algorithm by having to repeatedly access memory 108 to copy data points into registers 212 and/or to store computational results in memory 108, a number of memory I/O operations is greatly reduced or even completely eliminated, saving time and processing resources. In this manner, in embodiments, an efficient radix-4 FFT algorithm may be performed in place in registers 212, in contrast to conventional techniques which either use multiple stages of less efficient radix-2 FFTs or perform less efficient radix-4 FFTs that require many time consuming accesses to memory 108.

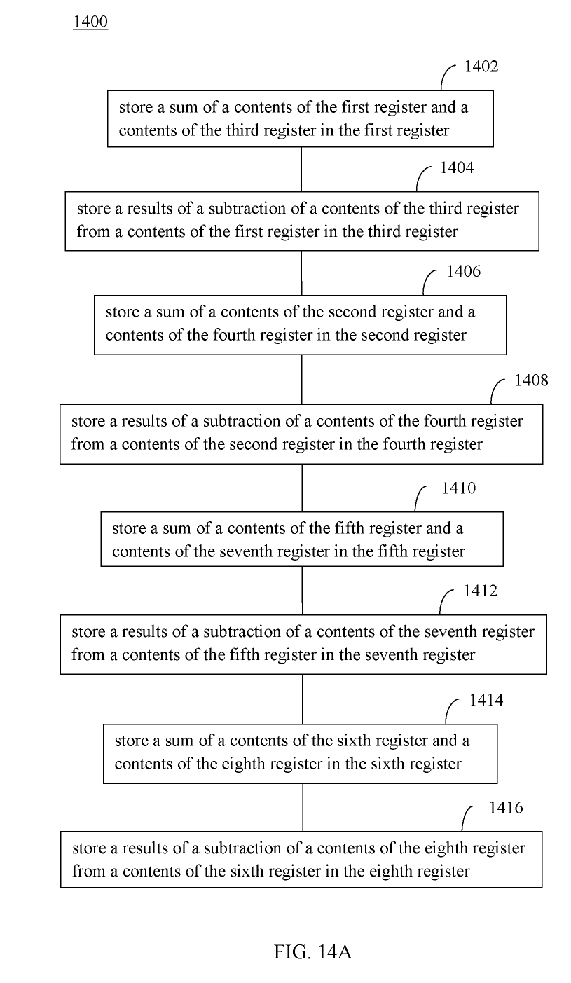

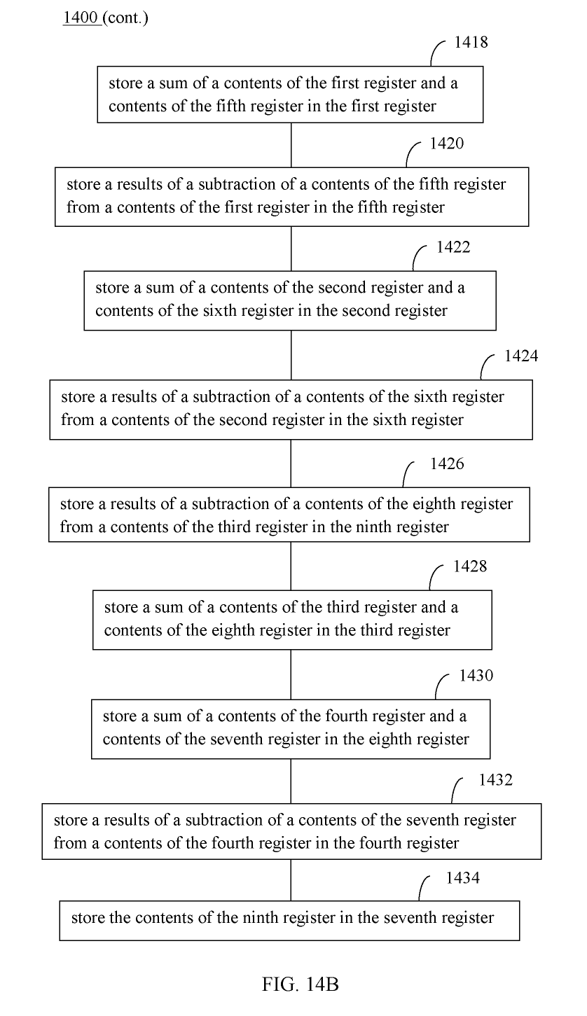

In embodiments, the radix-4 FFT algorithm may be performed in place in first-ninth registers 1304a-1304i using a relatively low number of instructions. For instance, FIGS. 14A and 14B show a flowchart 1400 for performing a radix-4 FFT in a manner that requires no more than nine registers, and requires no more than seventeen instructions to be performed, according to an example embodiment of the present invention. Flowchart 1400 may be performed in step 1210 (shown in FIG. 12) by any one or more of first-third radix-N FFT modules 904, 906, and 910 (shown in FIG. 9). Other structural and operational embodiments will be apparent to persons skilled in the relevant art(s) based on the discussion regarding flowchart 1400. Note that the steps of flowchart 1400 may be performed in orders other than the order shown in FIGS. 14A and 14B as long as the generated register contents remain consistent. Flowchart 1400 is described as follows.

Referring to FIG. 14A, in step 1402, a sum of a contents of the first register and a contents of the third register is stored in the first register. For instance, radix-4 FFT module 1302 may be configured to sum a contents of first register 1304a (which is initially the real portion of the first data point) and a contents of third register 1304c (which is initially the real portion of the second data point) to generate a first sum, and to store the first sum in first register 1304a.

In step 1404, a results of a subtraction of a contents of the third register from a contents of the first register is stored in the third register. For instance, radix-4 FFT module 1302 may be configured to subtract a contents of third register 1304c (which is initially the real portion of the second data point) from a contents of first register 1304a (which is the first sum) to generate a first subtraction results, and to store the first subtraction results in third register 1304c.

In step 1406, a sum of a contents of the second register and a contents of the fourth register is stored in the second register. For instance, radix-4 FFT module 1302 may be configured to sum a contents of second register 1304b (which is initially the imaginary portion of the first data point) and a contents of fourth register 1304d (which is initially the imaginary portion of the second data point) to generate a second sum, and to store the second sum in second register 1304b.

In step 1408, a results of a subtraction of a contents of the fourth register from a contents of the second register is stored in the fourth register. For instance, radix-4 FFT module 1302 may be configured to subtract a contents of fourth register 1304d (which is initially the imaginary portion of the second data point) from a contents of second register 1304b (which is the second sum) to generate a second subtraction results, and to store the second subtraction results in fourth register 1304d.

In step 1410, a sum of a contents of the fifth register and a contents of the seventh register is stored in the fifth register. For instance, radix-4 FFT module 1302 may be configured to sum a contents of fifth register 1304e (which is initially the real portion of the third data point) and a contents of seventh register 1304g (which is initially the real portion of the fourth data point) to generate a third sum, and to store the third sum in fifth register 1304e.

In step 1412, a results of a subtraction of a contents of the seventh register from a contents of the fifth register is stored in the seventh register. For instance, radix-4 FFT module 1302 may be configured to subtract a contents of seventh register 1304g (which is initially the real portion of the fourth data point) from a contents of fifth register 1304e (which is the third sum) to generate a third subtraction results, and to store the third subtraction results in seventh register 1304g.

In step 1414, a sum of a contents of the sixth register and a contents of the eighth register is stored in the sixth register. For instance, radix-4 FFT module 1302 may be configured to sum a contents of sixth register 1304f (which is initially the imaginary portion of the third data point) and a contents of eighth register 1304h (which is initially the imaginary portion of the fourth data point) to generate a fourth sum, and to store the fourth sum in sixth register 1304f.

In step 1416, a results of a subtraction of a contents of the eighth register from a contents of the sixth register is stored in the eighth register. For instance, radix-4 FFT module 1302 may be configured to subtract a contents of eighth register 1304h (which is initially the imaginary portion of the fourth data point) from a contents of sixth register (which is the fourth sum) to generate a fourth subtraction results, and to store the fourth subtraction results in eighth register 1304h.

Referring to FIG. 4B, in step 1418, a sum of a contents of the first register and a contents of the fifth register is stored in the first register. For instance, radix-4 FFT module 1302 may be configured to sum a contents of first register 1304a (which is the first sum) and a contents of fifth register 1304e (which is the third sum) to generate a fifth sum, and to store the fifth sum in first register 1304a.

In step 1420, a results of a subtraction of a contents of the fifth register from a contents of the first register is stored in the fifth register. For instance, radix-4 FFT module 1302 may be configured to subtract a contents of fifth register 1304e (which is the third sum) from a contents of first register 1304a (which is the fifth sum) to generate a fifth subtraction results, and to store the fifth subtraction results in fifth register 1304e.

In step 1422, a sum of a contents of the second register and a contents of the sixth register is stored in the second register. For instance, radix-4 FFT module 1302 may be configured to sum a contents of second register 1304b (which is the second sum) and a contents of sixth register 1304f (which is the fourth sum) to generate a sixth sum, and to store the sixth sum in second register 1304b.

In step 1424, a results of a subtraction of a contents of the sixth register from a contents of the second register is stored in the sixth register. For instance, radix-4 FFT module 1302 may be configured to subtract a contents of sixth register 1304f (which is the fourth sum) from a contents of second register 1304b (which is the sixth sum) to generate a sixth subtraction results, and to store the sixth subtraction results in sixth register 1304f.

In step 1426, a results of a subtraction of a contents of the eighth register from a contents of the third register is stored in the ninth register. For instance, radix-4 FFT module 1302 may be configured to subtract a contents of eighth register 1304h (which is the fourth subtraction results) from a contents of third register 1304c (which is the first subtraction results) to generate a seventh subtraction results, and to store the seventh subtraction results in ninth register 1304i.

In step 1428, a sum of a contents of the third register and a contents of the eighth register is stored in the third register. For instance, radix-4 FFT module 1302 may be configured to sum a contents of third register 1304c (which is the first subtraction results) and a contents of eighth register 1304h (which is the fourth subtraction results) to generate a seventh sum, and to store the seventh sum in third register 1304c.

In step 1430, a sum of a contents of the fourth register and a contents of the seventh register is stored in the eighth register. For instance, radix-4 FFT module 1302 may be configured to sum a contents of fourth register 1304d (which is the second subtraction results) and a contents of seventh register 1304g (which is the third subtraction results) to generate an eighth sum, and to store the eighth sum in eighth register 1304h.

In step 1432, a results of a subtraction of a contents of the seventh register from a contents of the fourth register is stored in the fourth register. For instance, radix-4 FFT module 1302 may be configured to subtract a contents of seventh register 1304g (which is the third subtraction results) from a contents of fourth register 1304d (which is the second subtraction results) to generate an eighth subtraction results, and to store the eighth subtraction results in fourth register 1304d.

In step 1434, the contents of the ninth register is stored in the seventh register. For instance, radix-4 FFT module 1302 (or other mechanism) may be configured to store the contents of ninth register 1304i (which is the seventh subtraction results) in seventh register 1304g.

As a result of the in-place FFT operation of flowchart 1400, a real portion of the first output data point is stored in first register 1304a, an imaginary portion of the first output data point is stored in second register 1304b, a real portion of the second output data point is stored in third register 1304c, an imaginary portion of the second output data point is stored in fourth register 1304d, a real portion of the third output data point is stored in fifth register 1304e, an imaginary portion of the third output data point is stored in sixth register 1304f, a real portion of the fourth output data point is stored in seventh register 1304g, and an imaginary portion of the fourth output data point is stored in eighth register 1304h.

Note that first permutation module 902, first radix-N FFT module 904, second radix-N FFT module 906, second permutation module 908, and third radix-N FFT module 910 may be implemented in hardware, software, firmware, or any combination thereof.

For example, first permutation module 902, first radix-N FFT module 904, second radix-N FFT module 906, second permutation module 908, and/or third radix-N FFT module 910 may be implemented as one or more processors and/or as computer code configured to be executed in one or more processors, such as an ARM CPU. Alternatively, first permutation module 902, first radix-N FFT module 904, second radix-N FFT module 906, second permutation module 908, and/or third radix-N FFT module 910 may be implemented as hardware logic/electrical circuitry. Tables 1000 and 1100 may be stored in memory 108 or other storage device in any suitable form, such as in the form of a table, a data array, a database, etc.

### Example Embodiments for Handling Twiddle Factors

Example embodiments are described in this section for the optional handling of twiddle factors for FFT modules 202 and 206. Twiddle factors are scaling factors that are used in an FFT to improve the dynamic range of signals, such as audio signals.

Embodiments described herein may include scaling with twiddle factors to improve dynamic range to a degree as desired, including scaling with twiddle factors configured to obtain a maximum possible dynamic range.

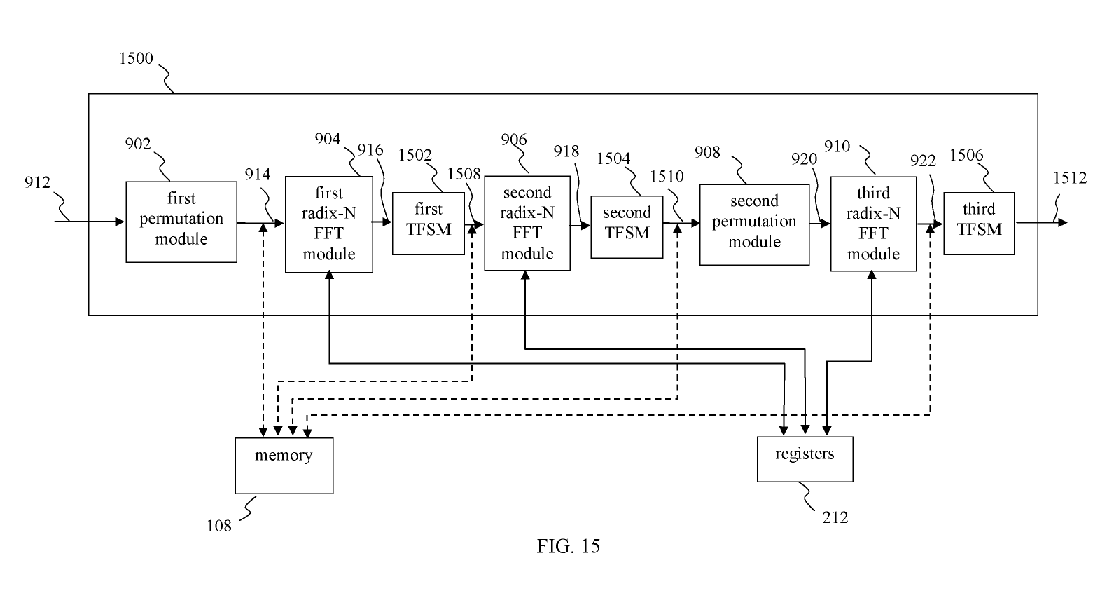

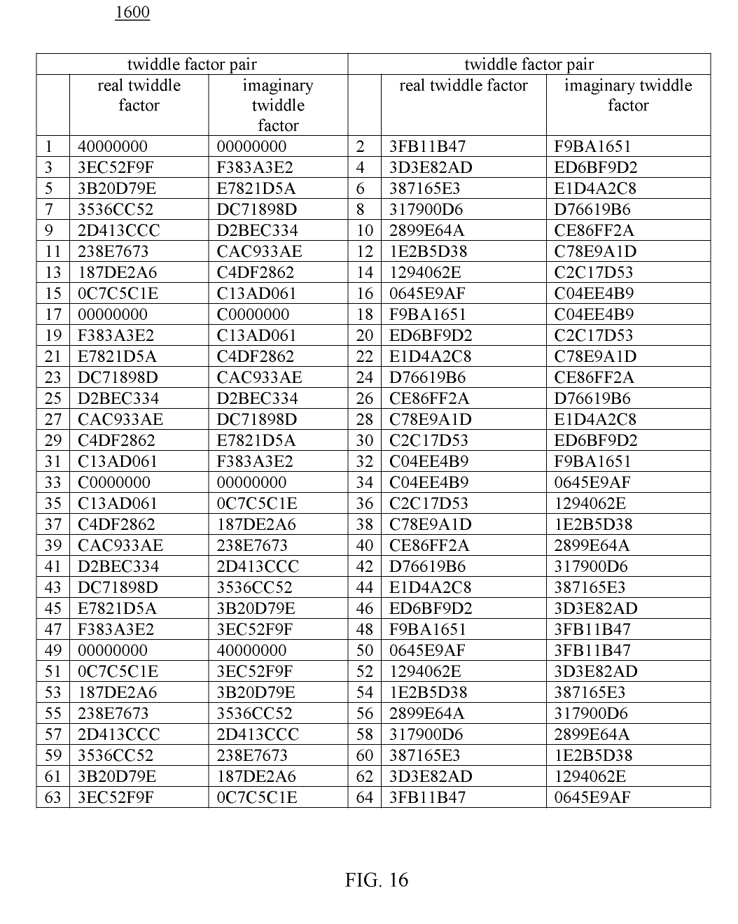

For example, FIG. 15 shows a radix-M FFT system 1500, according to an example embodiment of the present invention. Radix-M FFT system 1500 is configured to enable scaling of the outputs of first-third radix-N FFT modules 904, 908, and 910 with twiddle factors. As shown in FIG. 15, system 1500 is generally similar to radix-M FFT system 900 shown in FIG. 9, with the addition of a first twiddle factor scaling module (TFSM) 1502, a second TFSM 1504, and a third TFSM 1506. In embodiments, any one or more of TFSMs 1502, 1504, and 1506 may be present.

As shown in FIG. 15, first TFSM 1502 is positioned between first radix-N FFT module 904 and second radix-N FFT module 906. First TFSM 1502 receives second plurality of data points 916 (either from memory 108 or from module 904), and scales second plurality of data points 916 according to a predetermined set of twiddle factors. For example, if M is equal to 64, first TFSM 1502 may receive 64 data points in second plurality of data points 916, and may scale the 64 data points with a predetermined set of twiddle factors. TFSM 1502 may multiply each data point with a corresponding twiddle factor, and/or may perform any other arithmetic operation to scale each data point according to the predetermined set of twiddle factors. First TFSM 1502 generates a scaled second plurality of data points 1508, which is received by second radix-N FFT module 906 and/or is stored in memory 108.

For instance, in an embodiment, TFSM 1502 may be configured to scale the 64 data points of first plurality of data points 912 with the twiddle factors indicated in a table. For example, FIG. 16 shows a table 1600 that lists a set of twiddle factors for 64 data points, according to an embodiment of the present invention. In table 1600, each row lists two pairs of twiddle factors corresponding to two data points, for ease of illustration. The first twiddle factor in each pair corresponds to the real portion of the corresponding data point, and the second twiddle factor in each pair corresponds to the imaginary portion of the corresponding data point. The order of twiddle factors in table 1600 is sequential from left to right in each row, and is sequential on a row-by-row basis. In the example of FIG. 16, twiddle factors are listed in table 1600 in hexadecimal form. Table 1600 may be stored in memory 108 or other storage device in any suitable form, such as in the form of a table, a data array, a database, etc.

For example, a first row of table 1600 lists a first twiddle factor pair and a second twiddle factor pair. The first twiddle factor pair includes a real twiddle factor of 40000000 (hex) and an imaginary twiddle factor of 00000000 (hex). The second twiddle factor pair includes a real twiddle factor of 3FB11B47 (hex) and an imaginary twiddle factor of F9BA1651 (hex). TFSM 1502 may be configured to scale a first data point received in first plurality of data points 912 using the first twiddle factor pair, and each subsequent data point according to the corresponding twiddle factor pair. For instance, in an embodiment, TFSM 1502 may be configured to multiply the real portion of the first data point by the real twiddle factor of 40000000 (hex), and to multiply the imaginary portion of the first data point by the imaginary twiddle factor of 00000000 (hex) to determine the corresponding scaled real and imaginary portions of the first data point. In another embodiment, TFSM 1502 may be configured to scale each of the real and imaginary portions of the first data point using both of the real and imaginary twiddle factors of the first twiddle factor pair. For example, TFSM 1502 may calculate the scaled real portion of the first data point according to Equation 1 shown as follows:

ReDPnew=ReDPold×ReTF−ImDPold×ImTF Equation 1

where:

ReDPnew=the scaled real portion of the data point,

ReDPold=the real portion of the data point (prior to scaling),

ReTF=the real twiddle factor of the twiddle factor pair,

ImDPold=the imaginary portion of the received data point (prior to scaling), and

ImTF=the imaginary twiddle factor of the twiddle factor pair.

In a similar manner, TFSM 1502 may calculate the scaled imaginary portion of the first data point according to Equation 2 shown as follows:

ImDPnew=ReDPold×ImTF+ImDPold×ReTF Equation 2

where:

ImDPnew=the scaled imaginary portion of the data point.

TFSM 1502 may be configured to calculate scaled real and imaginary portions of each received data point according to Equations 1 and 2, or according to other algorithms.

In the current example of table 1600, each twiddle factor is shown as a 32 bit value. In other embodiments, twiddle factors may have other bits value lengths, including being 16 bit values. Embodiments of the present invention enable 32-bit twiddle factors to be used, as opposed to conventional techniques which use 16 bit twiddle factors. For example, registers 1304a-1304p of registers 212 shown in FIG. 13 may be 16 bit length registers (e.g., in an ARM CPU embodiment). Thus, a 32-bit twiddle factor may be stored in two registers. By preserving registers as described above, register space is available for storage of 32 bit twiddle factors in registers 212, and therefore TFSM 1502 may perform twiddle factor calculations using registers 212 (rather than accessing memory 108) to save computational time and processing resources.

By being able to use 32-bit twiddle factors, 16 additional twiddle factor bits are available, which enable much more accurate calculations to be performed, which thereby enable the preservation of dynamic range. For instance, in an embodiment, system 1500 may be configured as a 64 point FFT algorithm using 3 radix-4 FFT modules for a voice and/or streaming audio application. In such an application, the incoming data to system 1500 typically may be 16-bit linear PCM data. Embodiments enable high quality audio with large dynamic range to be achieved, because 32 bit twiddle factors may be applied to the 16 bit (or other bit length) data.

Second and third TFSMs 1504 and 1506 shown in FIG. 15, when present, function similarly to first TFSM 1502, as described above. As shown in FIG. 15, second TFSM 1504 is positioned between second radix-N FFT module 906 and second permutation module 908. Second TFSM 1504 receives third plurality of data points 918 (either from memory 108 or from module 906), and scales third plurality of data points 918 according to a predetermined set of twiddle factors. For example, if M is equal to 64, second TFSM 1504 may receive 64 data points in third plurality of data points 918, and may scale the 64 data points with a predetermined set of twiddle factors. For instance, TFSM 1504 may access a table similar to table 1600 shown in FIG. 16 to retrieve a set of twiddle factors. The table may store the same twiddle factors as shown in table 1600 or may include a different set of twiddle factors. Second TFSM 1504 generates a scaled third plurality of data points 1510, which is received by second permutation module 908 and/or is stored in memory 108.

As shown in FIG. 15, third TFSM 1506 is positioned following third radix-N FFT module 910. Third TFSM 1506 receives fourth plurality of data points 922 (either from memory 108 or from module 910), and scales fourth plurality of data points 922 according to a predetermined set of twiddle factors. For example, if M is equal to 64, third TFSM 1506 may receive 64 data points in fourth plurality of data points 922, and may scale the 64 data points with a predetermined set of twiddle factors. For instance, TFSM 1506 may access a table similar to table 1600 shown in FIG. 16 to retrieve a set of twiddle factors. The table may store the same twiddle factors as shown in table 1600 or may include a different set of twiddle factors. Third TFSM 1506 generates a scaled fourth plurality of data points 1512, which may be received in memory 108 and/or provided to a subsequent module (e.g., audio processing module 204 or time domain processing module 216 shown in FIG. 2).

Note that first-third TFSMs 1502, 1504, and 1506 may be implemented in hardware, software, firmware, or any combination thereof. For example, first-third TFSMs 1502, 1504, and/or 1506 may be implemented as one or more processors and/or computer code configured to be executed in one or more processors, such as an ARM CPU. Alternatively, first-third TFSMs 1502, 1504, and 1506 may be implemented as hardware logic/electrical circuitry.

### Example Computer Program Implementations

As described above, audio processor 104 (e.g., shown in FIGS. 1 and 2), system 900 (FIG. 9), and system 1500 (FIG. 15) may include hardware, software, firmware, or any combination thereof to perform at least a portion of their functions. As further described above, in an embodiment, audio processor 104, system 900, and system 1500 may be implemented in one or more computers, including a personal computer, a mobile computer (e.g., a laptop computer, a notebook computer, a handheld computer such as a personal digital assistant (PDA) or a Palm™ device, etc.), or a workstation. These example devices are provided herein purposes of illustration, and are not intended to be limiting. Embodiments of the present invention may be implemented in further types of devices, as would be known to persons skilled in the relevant art(s).

Devices in which embodiments may be implemented may include storage, such as storage drives, memory devices, and further types of computer-readable media. Examples of such computer-readable media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable media may store program modules that include logic for implementing audio processor 104, system 900, system 1500, input FFT module 202, audio processing module 204, output FFT module 206, time domain estimation module 214, and time domain processing module 216 (FIG. 2), first permutation module 902, first radix-N FFT module 904, second radix-N FFT module 906, second permutation module 908, and third radix-N FFT module 910 (FIG. 9), first-third TFSMs 1502, 1504, and 1506 (FIG. 15), flowchart 800 of FIG. 8, flowchart 1200 of FIG. 12, flowchart 1400 of FIGS. 14A and 14B, and/or further embodiments of the present invention described herein. Embodiments of the invention are directed to computer program products comprising such logic (e.g., in the form of program code or software) stored on any computer useable medium. Such program code, when executed in a processing unit (that includes one or more data processing devices), causes a device to operate as described herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for performing a fast Fourier transform (FFT) on a plurality of input data points that includes a first input data point, a second input data point, a third input data point, and a fourth input data point, comprising:
storing a real portion of the first input data point in a first register and an imaginary portion of the first input data point in a second register;
storing a real portion of the second input data point in a third register and an imaginary portion of the second input data point in a fourth register;
storing a real portion of the third input data point in a fifth register and an imaginary portion of the third input data point in a sixth register;
storing a real portion of the fourth input data point in a seventh register and an imaginary portion of the fourth input data point in an eighth register; and
performing operations on the first-fourth input data points in place in the first-eight registers and in a ninth register to generate a first output data point, a second output data point, a third output data point, and a fourth output data point.

2. The method of claim 1, wherein said performing operations on the first-fourth input data points in place in the first-eight registers and in a ninth register to generate a first output data point, a second output data point, a third output data point, and a fourth output data point comprises:
storing a sum of a contents of the first register and a contents of the third register in the first register;
storing a results of a subtraction of a contents of the third register from a contents of the first register in the third register;
storing a sum of a contents of the second register and a contents of the fourth register in the second register;
storing a results of a subtraction of a contents of the fourth register from a contents of the second register in the fourth register;
storing a sum of a contents of the fifth register and a contents of the seventh register in the fifth register;
storing a results of a subtraction of a contents of the seventh register from a contents of the fifth register in the seventh register;
storing a sum of a contents of the sixth register and a contents of the eighth register in the sixth register; and
storing a results of a subtraction of a contents of the eighth register from a contents of the sixth register in the eighth register.

3. The method of claim 2, wherein said performing operations on the first-fourth input data points in place in the first-eight registers and in a ninth register to generate a first output data point, a second output data point, a third output data point, and a fourth output data point further comprises:
storing a sum of a contents of the first register and a contents of the fifth register in the first register;
storing a results of a subtraction of a contents of the fifth register from a contents of the first register in the fifth register;
storing a sum of a contents of the second register and a contents of the sixth register in the second register;
storing a results of a subtraction of a contents of the sixth register from a contents of the second register in the sixth register;
storing a results of a subtraction of a contents of the eighth register from a contents of the third register in the ninth register;
storing a sum of a contents of the third register and a contents of the eighth register in the third register;
storing a sum of a contents of the fourth register and a contents of the seventh register in the eighth register;
storing a results of a subtraction of a contents of the seventh register from a contents of the fourth register in the fourth register; and
storing the contents of the ninth register in the seventh register;
wherein a real portion of the first output data point is stored in the first register, an imaginary portion of the first output data point is stored in the second register, a real portion of the second output data point is stored in the third register, an imaginary portion of the second output data point is stored in the fourth register, a real portion of the third output data point is stored in the fifth register, an imaginary portion of the third output data point is stored in the sixth register, a real portion of the fourth output data point is stored in the seventh register, and an imaginary portion of the fourth output data point is stored in the eighth register.

4. A system for processing a plurality of input data points that include a first input data point, a second input data point, a third input data point, and a fourth input data point, comprising:
a fast Fourier transform (FFT) module; and
a plurality of registers that includes a first register, a second register, a third register, a fourth register, a fifth register, a sixth register, a seventh register, an eighth register, and a ninth register;
wherein the FFT module is configured to store a real portion of the first input data point in the first register and an imaginary portion of the first input data point in the second register, a real portion of the second input data point in the third register and an imaginary portion of the second input data point in the fourth register, a real portion of the third input data point in the fifth register and an imaginary portion of the third input data point in the sixth register, and a real portion of the fourth input data point in the seventh register and an imaginary portion of the fourth input data point in the eighth register; and
wherein the FFT module is configured to perform operations on the first-fourth input data points in place in the first-eight registers and in the ninth register to generate a first output data point, a second output data point, a third output data point, and a fourth output data point.

5. The system of claim 4, wherein the FFT module is configured to sum a contents of the first register and a contents of the third register to generate a first sum, and to store the first sum in the first register,
wherein the FFT module is configured to subtract a contents of the third register from a contents of the first register to generate a first subtraction results, and to store the first subtraction results in the third register;
wherein the FFT module is configured to sum a contents of the second register and a contents of the fourth register to generate a second sum, and to store the second sum in the second register;
wherein the FFT module is configured to subtract a contents of the fourth register from a contents of the second register to generate a second subtraction results, and to store the second subtraction results in the fourth register;
wherein the FFT module is configured to sum a contents of the fifth register and a contents of the seventh register to generate a third sum, and to store the third sum in the fifth register;
wherein the FFT module is configured to subtract a contents of the seventh register from a contents of the fifth register to generate a third subtraction results, and to store the third subtraction results in the seventh register;
wherein the FFT module is configured to sum a contents of the sixth register and a contents of the eighth register to generate a fourth sum, and to store the fourth sum in the sixth register; and
wherein the FFT module is configured to subtract a contents of the eighth register from a contents of the sixth register to generate a fourth subtraction results, and to store the fourth subtraction results in the eighth register.

6. The system of claim 5, wherein the FFT module is configured to sum a contents of the first register and a contents of the fifth register to generate a fifth sum, and to store the fifth sum in the first register;
wherein the FFT module is configured to subtract a contents of the fifth register from a contents of the first register to generate a fifth subtraction results, and to store the fifth subtraction results in the fifth register;
wherein the FFT module is configured to sum a contents of the second register and a contents of the sixth register to generate a sixth sum, and to store the sixth sum in the second register;
wherein the FFT module is configured to subtract a contents of the sixth register from a contents of the second register to generate a sixth subtraction results, and to store the sixth subtraction results in the sixth register;
wherein the FFT module is configured to subtract a contents of the eighth register from a contents of the third register to generate a seventh subtraction results, and to store the seventh subtraction results in the ninth register;
wherein the FFT module is configured to sum a contents of the third register and a contents of the eighth register to generate a seventh sum, and to store the seventh sum in the third register;
wherein the FFT module is configured to sum a contents of the fourth register and a contents of the seventh register to generate an eighth sum, and to store the eighth sum in the eighth register;
wherein the FFT module is configured to subtract a contents of the seventh register from a contents of the fourth register to generate an eighth subtraction results, and to store the eighth subtraction results in the fourth register;
wherein the FFT module is configured to store the contents of the ninth register in the seventh register; and
wherein a real portion of the first output data point is stored in the first register, an imaginary portion of the first output data point is stored in the second register, a real portion of the second output data point is stored in the third register, an imaginary portion of the second output data point is stored in the fourth register, a real portion of the third output data point is stored in the fifth register, an imaginary portion of the third output data point is stored in the sixth register, a real portion of the fourth output data point is stored in the seventh register, and an imaginary portion of the fourth output data point is stored in the eighth register.

7. A method for performing a radix-M fast Fourier transform (FFT), comprising:
receiving a first plurality of data points in a first order;
reordering the first plurality of data points into a second order;
performing a radix-N FFT operation on the first plurality of data points in groups of N data points received according to the second order to generate a second plurality of data points;
performing a radix-N FFT operation on the second plurality of data points in groups of N data points sequentially received to generate a third plurality of data points;
reordering the third plurality of data points into a third order; and
performing a radix-N FFT operation on the third plurality of data points in groups of N data points received according to the third order to generate a fourth plurality of data points.

8. The method of claim 7, wherein M is equal to 64 and N is equal to 4.

9. The method of claim 8, wherein said receiving a first plurality of data points in a first order comprises:
receiving sixty four data points that are ordered data point 0 through data point 63; and
wherein said reordering the first plurality of data points into a second order comprises:
reordering the sixty four data points into the following order of data point 0, data point 32, data point 16, data point 48, data point 8, data point 40, data point 24, data point 56, data point 4, data point 36, data point 20, data point 52, data point 12, data point 44, data point 28, data point 60, data point 2, data point 34, data point 18, data point 50, data point 10, data point 42, data point 26, data point 58, data point 6, data point 38, data point 22, data point 54, data point 14, data point 46, data point 30, data point 62, data point 1, data point 33, data point 17, data point 49, data point 9, data point 41, data point 25, data point 57, data point 5, data point 37, data point 21, data point 53, data point 13, data point 45, data point 29, data point 61, data point 3, data point 35, data point 19, data point 51, data point 11, data point 43, data point 27, data point 59, data point 7, data point 39, data point 23, data point 55, data point 15, data point 47, data point 31, and data point 63.

10. The method of claim 8, wherein said reordering the third plurality of data points into a third order comprises:
receiving the third plurality of data points as sixty four data points that are ordered data point 0 through data point 63; and
reordering the sixty four data points into the following order of data point 0, data point 4, data point 8, data point 12, data point 16, data point 20, data point 24, data point 28, data point 32, data point 36, data point 40, data point 44, data point 48, data point 52, data point 56, data point 60, data point 1, data point 5, data point 9, data point 13, data point 17, data point 21, data point 25, data point 29, data point 33, data point 37, data point 41, data point 45, data point 49, data point 53, data point 57, data point 61, data point 2, data point 6, data point 10, data point 14, data point 18, data point 22, data point 26, data point 30, data point 34, data point 38, data point 42, data point 46, data point 50, data point 54, data point 58, data point 62, data point 3, data point 7, data point 11, data point 15, data point 19, data point 23, data point 27, data point 31, data point 35, data point 39, data point 43, data point 47, data point 51, data point 55, data point 59, and data point 63.

11. The method of claim 8, further comprising:
scaling at least one of the second plurality of data points, third plurality of data points, and fourth plurality of data points according a corresponding set of twiddle factors.

12. The method of claim 8, wherein said performing a radix-4 FFT operation on the first plurality of data points in groups of 4 data points received according to the second order to generate a second plurality of data points comprises:
receiving a first group of four data points of the first plurality of data points that includes a first input data point, a second input data point, a third input data point, and a fourth input data point in the second order;
storing a real portion of the first input data point in a first register and an imaginary portion of the first input data point in a second register;
storing a real portion of the second input data point in a third register and an imaginary portion of the second input data point in a fourth register;
storing a real portion of the third input data point in a fifth register and an imaginary portion of the third input data point in a sixth register;
storing a real portion of the fourth input data point in a seventh register and an imaginary portion of the fourth input data point in an eighth register; and
performing operations on the first-fourth input data points in place in the first-eight registers and in a ninth register to generate a first output data point, a second output data point, a third output data point, and a fourth output data point.

13. A system for performing a radix-M fast Fourier transform (FFT), comprising:
a first permutation module configured to receive a first plurality of data points in a first order, and to reorder the first plurality of data points into a second order;
a first FFT module configured to receive the first plurality of data points in the second order, and to perform a radix-N FFT operation on the first plurality of data points in groups of N data points received according to the second order to generate a second plurality of data points;
a second FFT module configured to receive the second plurality of data points, and to perform a radix-N FFT operation on the second plurality of data points in groups of N data points sequentially received to generate a third plurality of data points;
a second permutation module configured to receive the third plurality of data points, and to reorder the third plurality of data points into a third order; and
a third FFT module configured to receive the third plurality of data points in the third order, and to perform a radix-N FFT operation on the third plurality of data points in groups of N data points received according to the third order to generate a fourth plurality of data points.

14. The system of claim 13, wherein M is equal to 64 and N is equal to 4.

15. The system of claim 14, wherein the first permutation module receives the first plurality of data points in a first order as sixty four data points that are ordered data point 0 through data point 63; and
wherein the first permutation module is configured to reorder the sixty four data points into the following order of data point 0, data point 32, data point 16, data point 48, data point 8, data point 40, data point 24, data point 56, data point 4, data point 36, data point 20, data point 52, data point 12, data point 44, data point 28, data point 60, data point 2, data point 34, data point 18, data point 50, data point 10, data point 42, data point 26, data point 58, data point 6, data point 38, data point 22, data point 54, data point 14, data point 46, data point 30, data point 62, data point 1, data point 33, data point 17, data point 49, data point 9, data point 41, data point 25, data point 57, data point 5, data point 37, data point 21, data point 53, data point 13, data point 45, data point 29, data point 61, data point 3, data point 35, data point 19, data point 51, data point 11, data point 43, data point 27, data point 59, data point 7, data point 39, data point 23, data point 55, data point 15, data point 47, data point 31, and data point 63.

16. The system of claim 14, wherein the second permutation module receives the third plurality of data points as sixty four data points that are ordered data point 0 through data point 63; and
wherein the second permutation module is configured to reorder the sixty four data points into the following order of data point 0, data point 4, data point 8, data point 12, data point 16, data point 20, data point 24, data point 28, data point 32, data point 36, data point 40, data point 44, data point 48, data point 52, data point 56, data point 60, data point 1, data point 5, data point 9, data point 13, data point 17, data point 21, data point 25, data point 29, data point 33, data point 37, data point 41, data point 45, data point 49, data point 53, data point 57, data point 61, data point 2, data point 6, data point 10, data point 14, data point 18, data point 22, data point 26, data point 30, data point 34, data point 38, data point 42, data point 46, data point 50, data point 54, data point 58, data point 62, data point 3, data point 7, data point 11, data point 15, data point 19, data point 23, data point 27, data point 31, data point 35, data point 39, data point 43, data point 47, data point 51, data point 55, data point 59, and data point 63.

17. The system of claim 14, further comprising:
a scaling module configured to scale at least one of the second plurality of data points, third plurality of data points, and fourth plurality of data points according a corresponding set of twiddle factors.

18. The system of claim 14, wherein the first FFT module is configured to receive a first group of four data points of the first plurality of data points that includes a first input data point, a second input data point, a third input data point, and a fourth input data point in the second order;
wherein the first FFT module is configured to store a real portion of the first input data point in a first register and an imaginary portion of the first input data point in a second register;
wherein the first FFT module is configured to store a real portion of the second input data point in a third register and an imaginary portion of the second input data point in a fourth register;
wherein the first FFT module is configured to store a real portion of the third input data point in a fifth register and an imaginary portion of the third input data point in a sixth register;
wherein the first FFT module is configured to store a real portion of the fourth input data point in a seventh register and an imaginary portion of the fourth input data point in an eighth register; and
wherein the first FFT module is configured to perform operations on the first-fourth input data points in place in the first-eight registers and in a ninth register to generate a first output data point, a second output data point, a third output data point, and a fourth output data point.

19. The system of claim 18, further comprising:
an ARM processing module that includes the first FFT module and sixteen registers, the sixteen registers including the first-ninth registers.
